(19) United States
(12) Patent Application Publication
(10) Pub. No.: US 2019/0041628 A1
(43) Pub. Date: Feb. 7, 2019

(54) Thin Optical Ring

(71) Applicant: Joseph Kawecki, Moorestown, NJ (US)

(72) Inventor: Joseph Kawecki, Moorestown, NJ (US)

(21) Appl. No.: 15/668,912

(22) Filed: Aug. 4, 2017

(51) Int. Cl. G02B 25/00; G02B 7/00

(52) U.S. Cl. CPC G02B 25/002; G02B 25/008; G02B 7/002

(57) ABSTRACT

A ring that is molded of a single piece of thin optical lens configured with one opening for a finger, for quickly and easily viewing magnified objects, with little effort. Its one material body makes it simple to use, strong and is easily worn at all times. Furthermore, multiple pieces of different lens magnification types and strengths can be sandwiched and aligned together on the same finger, creating a multi use viewing piece, equivalent to reading glasses, magnifying lens, a microscope and a telescope.

### BACKGROUND

Monocles and lorgnettes were the earliest form of non attached to the ear spectacles, that were compact and simple to use. Finger rings have tried to replace these but have become bulky, more complicated, and less discreet. None have been especially popular with the public as an alternate use to standard spectacles because of their indiscreetness, bulkiness, expense, distorted view and complicated use.

This invention solves prior finger rings because it's thin construction makes it discreet and easy to use, by merely swiveling it when needed. It comes in different magnification lens strengths, inexpensive, and unlike finger rings with spheres, globes, etc. it's distortion free reading. Furthermore, multiple rings worn in a sandwiched arrangement enhance telescopic and microscopic viewing.

Citing prior art are these US patents;

1536365 Wiseman combined ring and reading glass 1922,

2223657 Baden finger ring 1940

3955884 Pesco magnifying lens holder assembly 1974

8644218 Kanbar emergency lorgnette 1996

5608203 Finkelstein credit cart with magnifying lens 1997

20010052245 Lovegrove finger ring having bezel and removable tablet 2001

20070115427 Sauer ring device with optical focusing mechanism 2007

20120038877 Burns jewelry with integrated reading glass lens 2012

20140268373 Selness comfortable finger tip mounted optical device 2014

### BRIEF SUMMARY

The present invention relates to an optical ring, worn at-all-times, discreetly on a finger, for quickly and easily reading, viewing an object distortion free, when such typical forms as magnifying lens, reading glasses, and other forms of magnification are not readily available or do not want to be carried.

The invention is a molded, one piece, flat, plastic body of an US half dollar coin-like thickness and size, with a viewing lens area and an opening for a finger. Its very thin body can be used singly or with multiple bodies, that can be sandwiched together, for more magnification. Simply swiveling or rotating each body around the finger, the lens area becomes hidden. Thus, the invention becomes a distortion free, handy, always available, but discreet tool for general and close up reading, plus telescopic and microscopic viewing.

The present invention does not intend to replace the typical magnification forms, but to supplement them discreetly, thus reducing the need for carrying spectacles around all the time and time spent looking for the typical magnification forms.

### BRIEF DESCRIPTION OF DRAWINGS

FIG. 1A is a birds eye view of a partial hand showing one optical ring (100) on a finger (103) in its, in-use, up position, of the viewable lens area (101) and the circular finger opening (102).

FIG. 2A is said birds eye rotated (105) approximately 90 degrees from the in-use, up position to an alternate, or non-use, side position.

FIG. 3B is said birds eye of optical rings' (100) and (104), the two sandwiched together with the viewable lens area (101) in alignment, in-usE, up position.

FIG. 4C is said birds eye rotated (105) 180 degrees from the up position, with the viewable lens area (101) in its non-use, fully hidden, discreet position.

### DETAILED DESCRIPTION

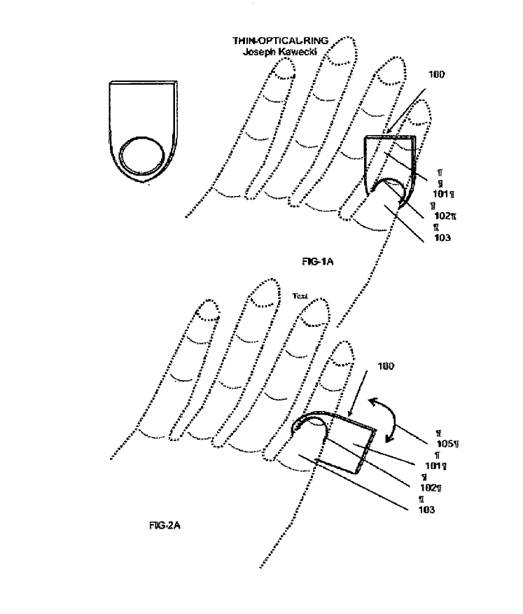

FIGS. 1-4. Depict the optical ring (100) made of a thin, transparent, homogeneous plastic body that incorporates one lens strength type of ophthalmic, telescopic, microscopic and or other known state of the art magnifying lens. At one end of the body is located an opening (102) large enough for a finger (103) to fit through, yet swivel. The other end of the body is the viewable lens area (101).

FIGS. 1A and 2A Depict two viewings, the up and the side positions, for alternate ways of looking through the viewable lens area (101) depending on the most comfortable location of the body between the eye and the viewed object.

FIG. 1A. The up position, the viewable lens area (101) is shown when the user uses one eye and looks over the top of the finger (103) through the viewable lens area.(101)

FIG. 2A The side position, the viewable lens area (101) is shown rotated (105) approximately 90 degrees around the finger (103) to a side. The user uses one eye and looks along the side of the finger (103) through the viewable lens area (101).

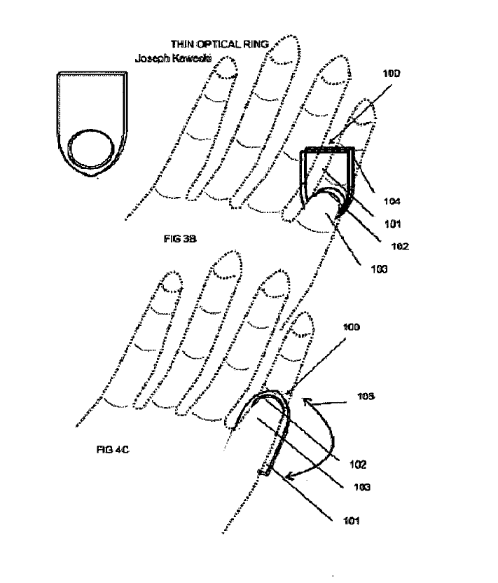

FIG. 3B Depicts one optical ring (100) and a second optical ring (104), each of different lens strength, sandwiching each ring's viewable lens area (101) in an aligned, up arrangement, position as shown, on the finger (103) The user simply rotates each ring as needed for higher magnification. While only shown are two rings, more than two rings can be affixed to the finger as dictated by the magnification needed

FIG. 4C. Depicts a stored, non-use position by rotating (105) an optical ring (100) approximately 180 degrees from the up use position as shown, or other position, with the viewable lens area (101) tucked against the underside of the hand, thus protecting, and hiding the optical ring's viewable lens area (101).

1. I claim: An optical ring device, referred to as a body, that's about the size and thickness of an US half dollar. It is worn discreetly on a finger for quickly and easily viewing and reading of an object by one eye.
The body is entirely less than 4 mm thick of one, thickness throughout.
The body is configured with a viewing lens area that has one magnification strength.
The body is tinted of one shade.
The body has one circular opening, with one sized to fit a finger comfortably yet large enough so the body can easily swivel around the finger.
The body is molded of a homogeneous, high strength, transparent, scratch resistant plastic.
The body has no moving or affixed parts.

2. The optical ring device of claim 1; I claim two bodies, or more, positioned together on one finger, each of different magnification strength. By sandwiching the viewing lens areas in alignment, a greater, more enhanced viewing of an object by one eye is achieved.
The sandwich arrangement works distortion free because each thin body can be stacked, tightly together on one finger. With each body's functional viewing lens area aligned, a more enhanced, magnified view is achieved similar to a telescope and microscope.
